(19) United States
(12) Patent Application Publication
(10) Pub. No.: US 2017/0223137 A1
(43) Pub. Date: Aug. 3, 2017

(54) FREQUENCY CAPPING FOR AN ONLINE CONTENT DELIVERY SYSTEM

(71) Applicant: LinkedIn Corporation, Mountain View, CA (US)

(72) Inventors: Sharon Yu, Sunnyvale, CA (US); Lihong Pei, San Jose, CA (US)

(21) Appl. No.: 15/010,263

(22) Filed: Jan. 29, 2016

(51) Int. Cl. H04L 29/08; H04W 72/04

(52) U.S. Cl. CPC H04L 67/327; H04W 72/0453; H04L 67/20

(57) ABSTRACT

Techniques are provided for determining a frequency cap rule that will be applied to one or more content requests associated with one or more users. In one technique, a frequency cap rule is determined based on performance of one or more content delivery campaigns. Thus, the frequency cap rule that is applied to a content request related to a content delivery campaign may change over time. In another technique, multiple frequency cap rules are determined to be applicable to a particular content request and one or more criteria are used to select one of the frequency cap rules to apply.

### TECHNICAL FIELD

The present invention relates to frequency capping and, more particularly, to dynamically updating frequency cap rules that dictate how often to display particular content.

### BACKGROUND

Frequency capping (Fcap) refers to restricting (or capping) the amount of times (frequency) a specific user (e.g., website visitor) is shown a certain content item (or set of related content items) within a period of time. For example, a frequency cap of “3 per 24 hours” for a particular content item means that, after exposing a particular user to the same ad three times, the particular user will not be shown that particular content item for 24 hours. Fcap can also be used to restrict display of a content item in response after the user has performed a particular action. For example, a frequency cap of “3 per 24 hours” for selecting a content item means that, after a user has selected (e.g., clicked on) the same content item three times, the user will not be shown that content item for 24 hours. A frequency cap of “1 per lifetime” for a particular action means that after a user has performed the particular action (e.g., purchased, downloaded, or viewed an associated video), the corresponding content item will no longer be shown to that user.

Current approaches for implementing a frequency cap are inefficient and static. In one approach, a content provider establishes a frequency cap for its associated content items. That frequency cap stays in place throughout a delivery campaign that involves displaying the content items to different users. Thus, frequency caps tend to be fixed configurations used for an extended period of time without consideration of changes in traffic patterns or of user interactions with the associated content items. Another downside to current approaches is that, for content provider initialized frequency caps, such frequency caps require a content provider to have an accurate estimation of the performance of a content delivery campaign while considering the current user traffic from one or more publishers, which estimation is quite difficult.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that depicts a system for distributing content items through a publisher to one or more end-users, in an embodiment;

FIG. 2 is a block diagram that depicts elements of a content exchange, in an embodiment;

FIG. 3 is a block diagram that depicts additional elements of a frequency cap component, in an embodiment;

FIG. 4 is a block diagram that depicts a system for computing multiple types of frequency cap rules, in an embodiment;

FIG. 5 is a block diagram that depicts a system for selecting frequency cap rules from different frequency rule stores, in an embodiment;

FIG. 6 is a flow diagram that depicts a process for identifying one or more frequency cap rules in response to a request for a frequency cap rule, in an embodiment;

FIG. 7 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Techniques are provided for determining a frequency cap rule that will be applied to one or more content requests associated with one or more users. In one technique, a frequency cap rule is determined based on performance of one or more content delivery campaigns. Thus, the frequency cap rule that is applied to a content request related to a content delivery campaign may change over time. In another technique, multiple frequency cap rules are determined to be applicable to a particular content request and one or more criteria are used to select one of the frequency cap rules to apply.

### Competing Goals

There are two types of goals of a frequency cap, depending on the viewpoint of the parties involved. From the perspective of a publisher (which displays content specifically requested by users) and a content exchange (which provides non-user requested content to one or more publishers), a goal is to provide a pleasant user experience without showing repeated ads too frequently. From the perspective of a content provider (which provides content items to the content exchange for distribution to one or more publishers), a goal is to maximize one of the following objectives: reaching a particular audience, optimizing user selection (e.g., click through rate), and increasing conversion (e.g., users purchasing a product or downloading an application). Sometimes these goals may conflict. For example, a publisher may not want more than three content items to be displayed to any particular user within a week while an advertiser may want to allow any user to be presented a particular content item at least ten times in a week in order to achieve the intended conversion.

### System Overview

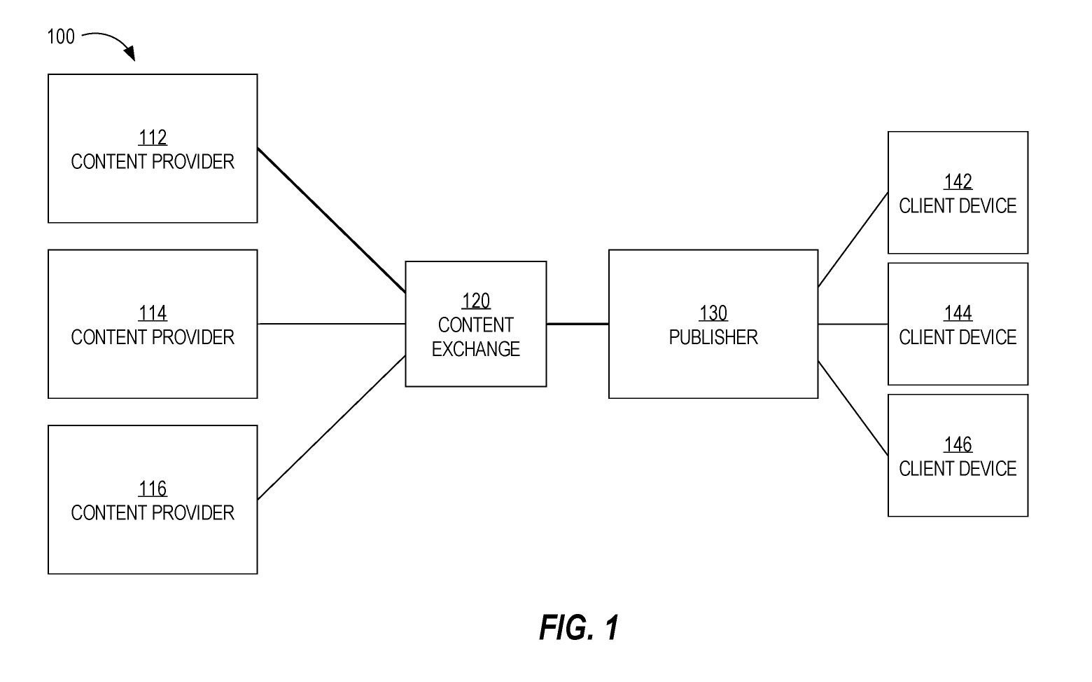

FIG. 1 is a block diagram that depicts a system 100 for distributing content items through a publisher to one or more end-users, in an embodiment. System 100 includes content providers 112-116, a content exchange 120, a publisher 130, and client devices 142-146. Although three content providers are depicted, system 100 may include more or less content providers. Similarly, system 100 may include more than one publisher and more or less client devices.

Content providers 112-116 interact with content exchange 120 (e.g., over a network, such as a LAN, WAN, or the Internet) to enable content items to be presented, though publisher 130, to end-users operating client devices 142-146. Thus, content providers 112-116 provide content items to content exchange 120, which in turn selects content items to provide to publisher 130 for presentation to users of client devices 142-146. However, at the time that content provider 112 registers with content exchange 120, neither party may know which end-users or client devices will receive content items from content provider 112, unless a target audience specified by content provider 112 is small enough.

An example of a content provider includes an advertiser. An advertiser of a product or service may be the same party as the party that makes or provides the product or service. Alternatively, an advertiser may contract with a producer or service provider to market or advertise a product or service provided by the producer/service provider. Another example of a content provider is an online ad network that contracts with multiple advertisers to provide content items (e.g., advertisements) to end users, either through publishers directly or indirectly through content exchange 120.

Publisher 130 provides its own content to client devices 142-146 in response to requests initiated by users of client devices 142-146. The content may be about any topic, such as news, sports, finance, and traveling. Publishers may vary greatly in size and influence, such as Fortune 500 companies, social network providers, and individual bloggers. A content request from a client device may be in the form of a HTTP request that includes a Uniform Resource Locator (URL) and may be issued from a web browser or a software application that is configured to only communicate with publisher 130 (and/or its affiliates). A content request may be a request that is immediately preceded by user input (e.g., selecting a hyperlink on web page) or may initiated as part of a subscription, such as through a Rich Site Summary (RSS) feed. In response to a request for content from a client device, publisher 130 provides the requested content (e.g., a web page) to the client device.

Simultaneously or immediately before or after the requested content is sent to a client device, a content request is sent to content exchange 120. That request is sent (over a network, such as a LAN, WAN, or the Internet) by publisher 130 or by the client device that requested the original content from publisher 130. For example, a web page that the client device renders includes one or more calls (or HTTP requests) to content exchange 120 for one or more content items. In response, content exchange 120 provides (over a network, such as a LAN, WAN, or the Internet) one or more particular content items to the client device directly or through publisher 130. In this way, the one or more particular content items may be presented (e.g., displayed) concurrently with the content requested by the client device from publisher 130.

A content item may comprise an image, a video, audio, text, graphics, or any combination thereof. A content item may also include a link (or URL) such that, when a user selects (e.g., with a finger on a touchscreen or with a cursor of a mouse device) the content item, a (e.g., HTTP) request is sent over a network (e.g., the Internet) to a destination indicated by the link. In response, content of a web page corresponding to the link may be displayed on the user's client device.

Examples of client devices 142-146 include desktop computers, laptop computers, tablet computers, wearable devices, video game consoles, and smartphones.

### Bidders

In a related embodiment, system 100 also includes one or more bidders (not depicted). A bidder is a party that is different than a content provider, that interacts with content exchange 120, and that bids for space (on one or more publishers, such as publisher 130) to present content items on behalf of multiple content providers. Thus, a bidder is another source of content items that content exchange 120 may select for presentation through publisher 130. Thus, a bidder acts as a content provider to content exchange 120 or publisher 130. Examples of bidders include AppNexus, DoubleClick, and LinkedIn. Because bidders act on behalf of content providers (e.g., advertisers), bidders create content delivery campaigns and, thus, specify user targeting criteria and, optionally, frequency cap rules, similar to a traditional content provider.

In a related embodiment, system 100 includes one or more bidders but no content providers. However, embodiments described herein for dynamically changing frequency cap rules and consolidating multiple frequency cap rules are applicable to any of the above-described system arrangements.

### Content Delivery Campaigns

Each content provider establishes a content delivery campaign with content exchange 120. A content delivery campaign includes (or is associated with) one or more content items. Thus, the same content item may be presented to users of client devices 142-146. Alternatively, a content delivery campaign may be designed such that the same user is (or different users are) presented different content items from the same campaign. For example, the content items of a content delivery campaign may have a specific order, such that one content item is not presented to a user before another content item is presented to that users.

A content delivery campaign has a start date/time and, optionally, a defined end date/time. For example, a content delivery campaign may be to present a set of content items from Jun. 1, 2015 to Aug. 1, 2015, regardless of the number of times the set of content items are presented (“impressions”), the number of user selections of the content items (e.g., click throughs), or the number of conversions that resulted from the content delivery campaign. Thus, in this example, there is a definite (or “hard”) end date. As another example, a content delivery campaign may have a “soft” end date, where the content delivery campaign ends when the corresponding set of content items are displayed a certain number of times, when a certain number of users view, select or click on the set of content items, or when a certain number of users purchase a product/service associated with the content delivery campaign or fill out a particular form on a website.

A content delivery campaign may specify one or more targeting criteria that are used to determine whether to present a content item of the content delivery campaign to one or more users. Example factors include date of presentation, time of day of presentation, characteristics of a user to which the content item will be presented, attributes of a computing device that will present the content item, identity of the publisher, etc. Examples of characteristics of a user include demographic information, residence information, job title, employment status, academic degrees earned, academic institutions attended, former employers, current employer, number of connections in a social network, identity of some of those connections, number and type of skills, number of endorsements, and stated interests. Examples of attributes of a computing device include type of device (e.g., smartphone, tablet, desktop, laptop), current geographical location, operating system type and version, size of screen, etc.

For example, targeting criteria of a particular content delivery campaign may indicate that a content item is to be presented to users with at least one undergraduate degree, who are unemployed, who are accessing from South America, and where the request for content items is initiated by a smartphone of the user. If content exchange 120 receives, from a computing device, a request that does not satisfy the targeting criteria, then content exchange 120 ensures that any content items associated with the particular content delivery campaign are not sent to the computing device.

Instead of one set of targeting criteria, the same content delivery campaign may be associated with multiple sets of targeting criteria. For example, one set of targeting criteria may be used during one period of time of the content delivery campaign and another set of targeting criteria may be used during another period of time of the campaign. As another example, a content delivery campaign may be associated with multiple content items, one of which may be associated with one set of targeting criteria and another one of which is associated with a different set of targeting criteria. Thus, while one content request from publisher 130 may not satisfy targeting criteria of one content item of a campaign, the same content request may satisfy targeting criteria of another content item of the campaign.

Different content delivery campaigns that content exchange 120 manages may have different compensation schemes. For example, one content delivery campaign may compensate content exchange 120 for each presentation of a content item from the content delivery campaign (referred to herein as cost per impression or CPM). Another content delivery campaign may compensate content exchange 120 for each time a user interacts with a content item from the content delivery campaign, such as selecting or clicking on the content item (referred to herein as cost per click or CPC). Another content delivery campaign may compensate content exchange 120 for each time a user performs a particular action, such as purchasing a product or service, downloading a software application, or filling out a form (referred to herein as cost per action or CPA). Content exchange 120 may manage only campaigns that are of the same type of compensation scheme or campaigns that are of any combination of the three types of compensation scheme.

At the time of establishing a content delivery campaign with content exchange 120 or sometime later, a frequency cap rule for each content item (or for all content items) associated with the content delivery campaign is determined. The frequency cap rule may be specified by the content provider (e.g., content provider 112), content exchange 120, or publisher 130. For example, content provider 112 may specify a frequency cap rule for a content item of a content delivery campaign and content exchange 120 may specify a frequency cap rule for all content delivery campaigns from content provider 112. For example, even though a frequency cap rule of a content item of a content delivery campaign of content provider 112 has not been met (e.g., “3 impressions per day”), a frequency cap rule (established by content exchange 120) of the content provider 112 has been met (e.g., “6 impressions per day”), which is possible if content provider 112 has other content items from the same or different campaign that have been displayed to the user.

### Example Content Serving Process

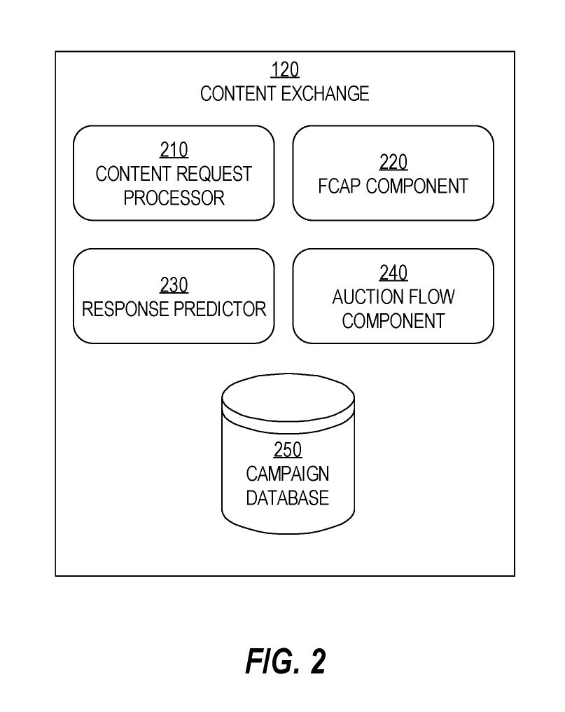

FIG. 2 is a block diagram that depicts elements of content exchange 120, in an embodiment. Content exchange 120 includes a content request processor 210, an Fcap component 220, a response predictor 230, an auction flow component 240, and a campaign database 250.

Fcap component 220 includes an Fcap processor 222, an Fcap rule database 224 and a user event database 226. Each of content request processor 210, Fcap component 220, response predictor 230, and auction flow component 240 may be implemented in hardware, software, or any combination of hardware and software.

Content request processor 210 receives a content item request from publisher 130. Content request processor 210 (or another hardware/software component in content exchange 120) determines one or more attributes related to the content item request, such as an identity of publisher 130, indication of context targets (i.e., where a content item will be displayed, such as a particular web page of a website and/or a location within the particular web page, such as the top of the page, the side of the page, or within a news/content feed), the current date, the current time of day, an identity of the client device (e.g., MAC address or IP address) to which one or more content items from content exchange 120 may be sent, a browser identifier of the client device, an identity of hardware/software attributes of the client device, and an identity of the user of the client device, such as an account/member identifier of a user who registered with an online service (e.g., a social networking service) and who is (presumably) operating the client device.

Campaign database 250 stores data about one or more content delivery campaigns. In addition to the information described previously, campaign database 250 may store a campaign identifier that uniquely identifies each content delivery campaign from other content delivery campaigns from the same content provider and, optionally, from all content providers.

Fcap rule database 224 stores data about multiple frequency cap rules. The frequency cap rules include rules established by content providers 112-116, by content exchange 120, and/or by publisher 130.

User event database 226 stores data about multiple events, each of which is associated with a user and/or client device. Examples of an event is the presentation of a particular content item (or “impression”), a user selection of a particular content item (or “user click”), and a conversion, such as a user purchase of a product or service associated with a particular content item or content delivery campaign, a download of software application associated with a particular content item or content delivery campaign, or a user filling out and submitting an online form associated with a particular content item or content delivery campaign. For example, one event may be that user A (with user identifier 123456) clicked on a content item associated with campaign B on Jan. 5, 2016. Another event may be that a user of client device C (with browser identifier 9876543) purchased a product associated with campaign D. Another event may be that a content item associated with campaign E was presented to a user of client device F (with IP address 45.6.240.10).

When two events pertain to the same user/device and the same content delivery campaign, then the events may be aggregated or combined. For example, if user A was presented with the same content item from content delivery campaign G at 9:20, 11:53, and 21:12 on the same day, then a single record may be created that indicates that user A was presented with the same content item from content delivery campaign G three times on a particular day. Alternatively, each event has its own entry in user event database 226. Later, when retrieving events for a single user or computing device, the event data will be aggregated and analyzed.

Because different publishers may not have access to the same information about a user or client device, some events that actually pertain to the same user or client device may not be associated with each other in user event database 226. For example, a user may use (1) client device 142 (e.g., a smartphone) to request content from publisher 130 and (2) client device 144 (e.g., a laptop computer) to request content from the same or different publisher, where the publisher relies on browser identifiers as a proxy for user identifiers or client device identifiers. Because the browser identifiers are different in this example, the corresponding events might not be aggregated or associated without further information.

Events and/or records stored in user event database 226 may be effectively aged out of user event database 226, depending on the type of content delivery campaign (e.g., CPI, CPC, or CPA). For example, a frequency cap rule of a content delivery campaign may be “3 per day.” Thus, impression events (or events indicating that a content item was presented to a user) that indicate a date and time that is greater than 24 hours old may be deleted from user event database 226 (or ignored).

Fcap processor 222 receives requests (e.g., via API calls) from content request processor 210 and, for each request, identifies one or more frequency cap rules. Each request includes a set of one or more identifiers, such as device identifiers, member identifiers, and/or browser identifiers. A request indicates one or more content delivery campaigns, a publisher that initiated the content request, and, optionally, a bidder. In an embodiment where multiple content delivery campaigns may be applicable to a user, content request processor 210 determines a set of content delivery campaigns that are applicable or relevant to the user and filters out campaigns that are not applicable. For example, if a content delivery campaign only targets medical doctors and a user associated with a content request from publisher 130 is not (or is not known to be) a medical doctor, then the content delivery campaign is filtered out from consideration and fcap processor 222 will not see that campaign from content request processor 210.

In response to a request, Fcap processor 222 uses fcap rule database 224 and user event database 226 to identify zero or more frequency cap rules that are applicable to the request, or rather, to the user or client device associated with the request. For example, if content exchange 120 has not previously received a user identifier included in the request (as indicated in user event database 226), then Fcap component 220 will not identify any frequency cap rule, since none would apply. As another example, Fcap component 220 may identify, in response to a request, three content delivery campaigns (from the same or different content providers) that are applicable to the request. The order in which the frequency cap rules and the user events are retrieved does not matter. Fcap processor 222 may first identify, from user event database 226, all the user events related to a user/device and then retrieve frequency cap rules from fcap rule database 224, or vice versa.

If Fcap processor 222 identifies one or more frequency rules, then Fcap processor 222 sends, to response predictor 230, identifiers of one or more content items that correspond to the identified frequency rule(s) and that should not be presented to a user associated with the request received from content request processor 210. Response predictor 230 filters out content items from consideration and sends, to auction flow component 240, a set of one or more content items to send to a publisher (e.g., publisher 130). Response predictor 230 makes a prediction for each of multiple candidate content items. The prediction may involve determine which of the multiple candidate content items is most likely to result in a click or conversion. Response predictor 230 may also take into account actual or predicted compensation for each candidate content item if the candidate content item ends up being presented.

### Different Types of Frequency Cap Rules

In an embodiment, content exchange 120 allows content providers 112-116 to specify frequency cap rules for their respective content items and/or content delivery campaigns. In this embodiment, content providers 112-116 may be allowed to specify one of two types of frequency cap rules: strict rules and flexible rules.

A strict rule from a content provider is one in which content exchange 120 applies no matter the frequency cap rules content exchange 120 might determine for the content provider. However, if a publisher (e.g., publisher 130) specifies a stricter frequency cap rule (e.g., 2 per day v. 3 per day), then content exchange 120 will apply the stricter frequency cap rule (if the two rules are applicable to the same content request from the publisher).

A flexible rule from a content provider is one in which content exchange 120 may apply initially to relevant content requests from publisher 130 until content exchange 120 obtains enough information to be confident in a frequency cap rule for the content provider and/or its content delivery campaigns.

In an embodiment, a single content provider may specify a strict rule for one or more content delivery campaigns and a flexible rule for one or more other content delivery campaigns. In a related embodiment, a single content provider may specify a strict rule for one or more content items of a particular content delivery campaign and a flexible rule for one or more other content items of the particular content delivery campaign.

Additionally or alternatively to allowing content providers to specify their own frequency cap rules, content exchange 120 allows publishers (e.g., publisher 130) to specify frequency cap rules for content items that will be presented through the publishers. For example, publisher 130 specifies “3 per day” regarding content items so that no single content item is displayed more than 3 times in a 24-hour period to any particular user/client device. As another example, publisher 130 specifies “8 per week” regarding content providers so that no user/client device is presented with more than 8 content items from a single content provider (which may have multiple content delivery campaigns that are concurrently active or running) in a 24-hour period, regardless of whether some of the 8 content items are different from each other.

In a related embodiment, some entities (e.g., some of content providers 112-116 and/or publisher 130) may specify strict rules and other entities (e.g., some of content providers 112-116 and/or publisher 130) may specify flexible rules.

### Content Provider Goals

In an embodiment, a content provider (e.g., content provider 112) is allowed to specify one of multiple goals and content exchange 120 determines one or more frequency cap rules for that content provider based on the specified goal. The content provider may or may not specify an initial frequency cap rule along with the specified goal. If a frequency cap rule is specified, then content exchange 120 may use that frequency cap rule initially and then modify the rule later on.

Example goals include reaching a wide audience, optimizing click through rate (or CTR), increasing conversions (e.g., purchase of a product/service associated with a content delivery campaign). For example, if content provider 112 (or a representative thereof) specifies an audience reach goal, then content exchange 120 may determine to have a frequency cap rule of 1 per day or 1 per week so that the same content item is not presented to any particular user very frequently.

As another example goal, if content provider 112 specifies a goal to optimize or increase CTR, then content exchange 120 may initially determine a frequency cap rule of 3 per day for content provider 112 and then modify that frequency cap rule later based on how well the corresponding content delivery campaign is performing (and/or how well other related content delivery campaigns are performing). The initial frequency cap rule determination may be based on how well a previous content delivery campaign performed. For example, if 4 per day resulted in an acceptable CTR for a previous content delivery campaign from content provider 112, then content exchange 120 may determine that, for a subsequent content delivery campaign from content provider 112, an initial frequency cap rule should also be 4 per day.

As another example goal (similar to CTR optimization), if content provider 112 specifies a goal to increase conversion, then content exchange 120 may initially determine a frequency cap rule of 3 per lifetime for content provider 112 and then modify that frequency cap rule later based on how well the corresponding content delivery campaign is performing (and/or how well other related content delivery campaigns are performing). The initial frequency cap rule determination may be based on how well a previous content delivery campaign performed. For example, if most users that converted (e.g., purchased a product associated with a previous content delivery campaign) did so only after being presented with a corresponding content item 4 times, then content exchange 120 may determine that, for a subsequent content delivery campaign from content provider 112, an initial frequency cap rule should be 4 per lifetime.

### Dynamic Frequency Cap Rules

In an embodiment, a frequency cap rule is dynamic in one or more ways. For example, content exchange 120 modifies a frequency cap rule of a content delivery campaign before the content delivery campaign ends.

As a related example, a content provider specifies a (e.g., flexible) frequency cap rule that is to be applied to all content delivery campaigns that the content provider initiates, but content exchange 120 modifies the frequency cap rule for one or more of the content delivery campaigns, either before or after the one or more content delivery campaigns begin.

As another related example, a frequency cap rule for a particular campaign changes (e.g., automatically by content exchange 120 or based on input from a content provider) for one or more users but remains unchanged for other users that the particular campaign targets.

In an embodiment, content exchange 120 modifies a frequency cap rule of a particular content delivery campaign based on campaign performance data related to that campaign and/or related to other content delivery campaigns. The other content delivery campaigns may be related to the particular content delivery campaign along one or more dimensions, such as being from the same content provider, having the same type of subject matter, having similar-sized content items, having similar formatted content items, being presented on the same publisher, being recent in time, being from the same bidder, targeting the same or similar segment of users (e.g., dentists over 50 years old in the United States), and/or same computer platform (e.g., smartphone or desktop).

### Offline Frequency Cap Rule Stores

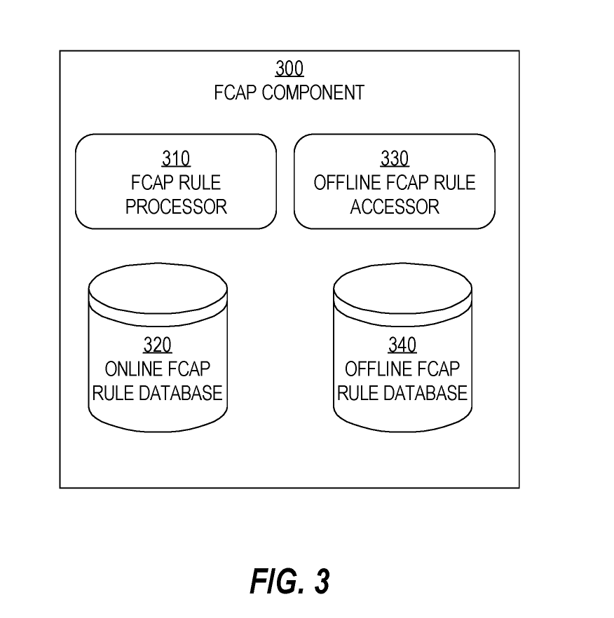

FIG. 3 is a block diagram that depicts additional elements of an fcap component 300, in an embodiment. Fcap component 300 is similar to fcap component 220 in FIG. 2. Fcap component 300 includes an fcap rule processor 310, an online fcap rule database 320, an offline fcap rule accessor 330, and an offline fcap rule database 340.

Online fcap rule database 320 stores frequency cap rules specified by one or more of content providers 112-116, one or more publishers, and/or one or more bidders. A subset of the frequency cap rules may be “flexible.”

Offline fcap rule database 340 stores frequency cap rules that content exchange 120 determines based on performance data associated with one or more content delivery campaigns. The performance data may be stored in database 340 or separately therefrom. Performance data may be aggregated data that is derived from analyzing user events (e.g., stored in user event database 226). For example, analysis of user events may reveal that, for a particular content delivery campaign, an average of 6 impressions of one or more content items related to the particular content delivery campaign were needed before an end-user performed a conversion. Thus, whatever the initial frequency cap rule (if one existed) for the particular content delivery campaign, a frequency cap rule of 6 per lifetime is created for, or at least associated with, the particular content delivery campaign.

As another example, analysis of user events may reveal that, for a particular content delivery campaign, an average of 3 impressions per day of a content item related to the particular content delivery campaign were needed before an end user selected the content item. Thus, whatever the initial frequency cap rule (if one existed) for the particular content delivery campaign, a frequency cap rule of 3 per day is created for, or at least associated with, the particular content delivery campaign.

Fcap rule accessor 330 (or another element of fcap component 300) performs the analysis user events. Analysis may involve grouping user events according to user or client device. For example, all user events that include the same user identifier or the same browser identifier are presumed to belong to a single user. Then, for each group of user events, the group of user events is further grouped by content delivery campaign and/or content provider. For example, for a particular user, 10 user events are associated with content provider 112 and 18 user events are associated with content provider 114. As another example, for a particular client device, 9 user events are associated with a first content delivery campaign and 8 user events are associated with a second content delivery campaign that is different than the first content delivery campaign (but may be initiated by the same content provider as the first content delivery campaign).

Alternatively, instead of grouping user events by user/client device and then by content provider/campaign, analysis may involve grouping by content provider/campaign and then by user/client device.

Returning to fcap component 300, fcap rule processor 310 receives requests (e.g., API calls from content request processor 210) for any applicable frequency cap rules. In response to a request, fcap rule processor 310 retrieves zero or more frequency cap rules from online fcap rule database 320 and sends a request for any applicable frequency cap rules from fcap rule accessor 330, which retrieves zero or more frequency cap rules from offline fcap rule database 340. Alternatively, fcap rule processor 310 bypasses fcap rule accessor 330 and retrieves zero or more frequency cap rules from offline fcap rule database 340.

### Consolidating Fcap Rules

In an embodiment, if fcap rule processor 310 identifies multiple frequency cap rules in response to a single request (e.g., one from online fcap rule database 320 and one or more from offline fcap rule database 340), then fcap rule processor 310 selects which frequency cap rule to apply. In one embodiment, the most restrictive frequency cap rule (in terms of least number of impressions per time period) is selected. For example, if one frequency cap rule is 3 per day and another frequency cap rule is 2 per day, then the latter frequency cap rule is selected. If one frequency cap rule is 6 per lifetime and another frequency cap rule is 2 per hour, then, if one frequency cap rule would prevent presentation of the associated content item, that frequency cap rule is applied and the associated content item is not presented.

In some instances, fcap rule processor 310 may have to select from among more than two frequency cap rules. For example, in response to a single request for frequency cap rules, fcap rule processor 310 may identify a content provider (e.g., flexible) frequency cap rule, a publisher frequency cap rule, a bidder frequency cap rule, and a content exchange cap rule. One or more of these frequency cap rules may be (a) specified by the corresponding parties (e.g., the content provider or by the bidder) and/or (b) derived by content exchange 120 based on an analysis of user event database 226. From those rules, the most restrictive frequency cap rule is selected.

### Statistical Modeling

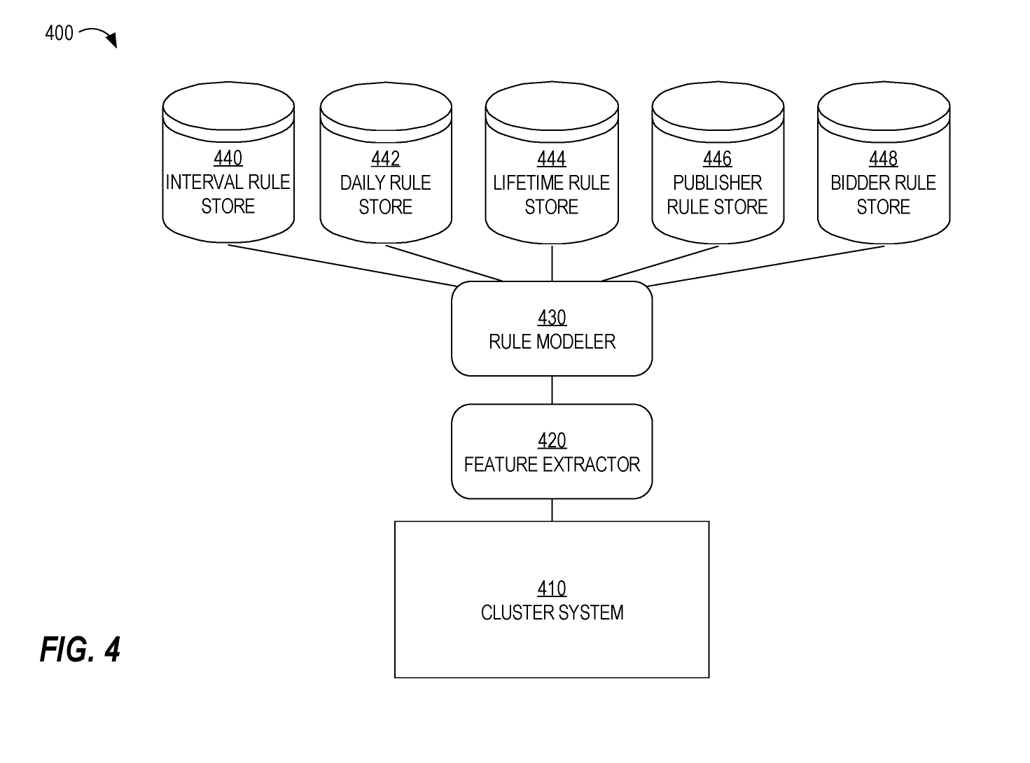

In an embodiment, one or more machine learning techniques are used to determine offline frequency cap rules for content providers 112-116, publishers, and/or bidders. FIG. 4 is a block diagram that depicts a system 400 for computing multiple types of frequency cap rules, in an embodiment. System 400 includes cluster system 410, feature extractor 420, rule modeler 430, and rule stores 440-448. Feature extractor 420 and rule modeler 430 may be implemented in software, hardware, or any combination of software and hardware.

Cluster system 410 is a system that stores user events and provides the user events to feature extractor 420. Event data that cluster system 410 provides to feature extractor 420 may be aggregated data that indicates a number of times a content item and/or content items from a content delivery campaign was presented to a user/client device over a period of time. Alternatively, cluster system 410 may provide raw event data or individual user events. Event data may also indicate that the user performed a particular action, such as clicking on a content item of the campaign or purchasing a product. An example of cluster system 410 is Apache Hadoop, which is an open-source software framework written in Java for distributed storage and distributed processing of large data sets on computer clusters built from commodity hardware.

Feature extractor 420 extracts feature values from each user event or record. Each user event or record corresponds to at least one content item. Example features include a user target, format of the content item, size of the content item, a context target, platform (e.g., laptop, smartphone, desktop, tablet), identity of a publisher, identity of a bidder, and identity of a content provider. If content exchange 120 interacts with only one publisher, then a publisher identity is not extracted. Similarly, if content exchange 120 interacts with only one bidder (or no bidders), then a bidder identity is not extracted.

“Format” of a content item may refer to any colors in the content item, whether the content item has a border, a number of characters in the content item, and/or whether the content item includes pricing information. Thus, there may be multiple format-related features.

“Size” of a content item may refer to a number of pixels, height and width measurements (e.g., 2″×3″), and/or a relative size of the content item to a display area of a screen of a client device (e.g., ⅙ of the display area). Thus, there may be multiple size-related features.

“User target” refers to an attribute of the user associated with the user event, such as demographic information, location information, academic information, employment information, endorsements, skills, etc. Thus, there may be multiple user target-related features.

“Context target” refers to where a content item is displayed. A context target may be, for example, a particular web page of a publisher and/or a particular position within a web page of the publisher, such as the top of the page, the right side of the page, the bottom of the page, and in a news feed in the center of the page. Thus, different web pages may be considered different content targets. Thus, there may be multiple context target-related features.

Rule modeler 430 uses the extracted feature values as training data to generate a statistical model. The training data includes the extracted feature values and, for each set of feature values corresponding to a set of related user events or to a record of aggregated data, a number of impressions and a user action (if any), such as a click, purchase, etc. Embodiments are not limited to any particular machine learning technique (e.g., logistic regression, linear regression, random forest) for generating the statistical model.

In a related embodiment, multiple statistical models are generated, one for each publisher, bidder, content provider, and/or user segment.

Input to a statistical model includes information about a content delivery campaign, which may or may not be “live” or currently running. Output of the model is a frequency cap rule, such as 1 per 10 hours or 3 per day, that may be associated with the content delivery campaign. A frequency cap rule is stored in one of rule stores 440-444. For example, interval frequency cap rules (e.g., per hour) are stored in interval rule store 440, daily frequency cap rules (i.e., per day) are stored in daily rule store 442, and lifetime frequency cap rules (i.e., per lifetime) are stored in lifetime rule store 444. (For CPA campaigns, one action per lifetime is reasonable. For CPM campaigns, multiple impressions per lifetime may be used.) Rule stores 440-444 comprise a campaign offline rule store. In an alternative embodiment, a single rule store is maintained that includes all types of frequency cap rules.

In an embodiment where there are multiple publishers, the model may be used to generate a frequency cap rule for each publisher. For example, a frequency cap rule for a high quality publisher may be 2 per day whereas a frequency cap rule for a low quality publisher may be 10 per day. Publisher frequency cap rules are stored in publisher rule store 446. If system 100 includes only one publisher initially, a frequency cap rule may still be generated for that publisher. Later, if another publisher may be added to system 100, then content exchange 120 will be ready to support the new publisher.

In an embodiment where there are multiple bidders, the model may be used to generate a frequency cap rule for each bidder. Bidder frequency cap rules are stored in bidder rule store 448. If system 100 includes only one bidder initially, a frequency cap rule may still be generated for that bidder. Later, if another bidder may be added to system 100, then content exchange 120 will be ready to support the new bidder.

### Offline Fcap Rule Processor

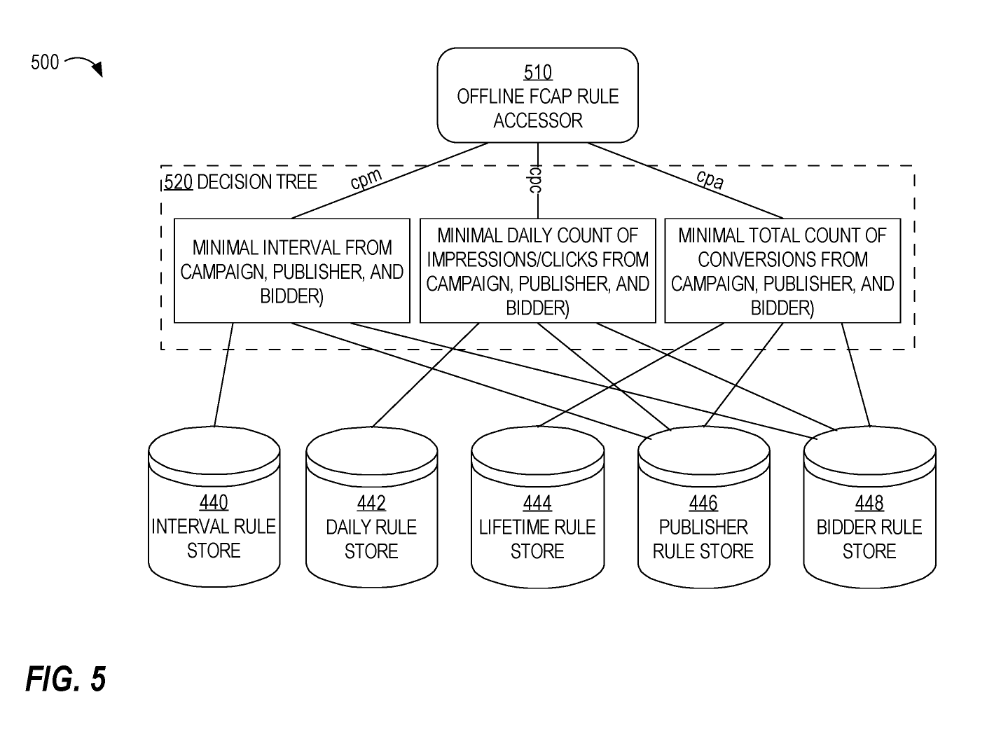

FIG. 5 is a block diagram that depicts a system 500 for selecting frequency cap rules from different frequency rule stores, in an embodiment. System 500 includes an offline fcap rule accessor 510, a decision tree 520 that indicates different consolidation rules depending on the type of content delivery campaign, and rule stores 440-448. Offline fcap rule accessor 510 may be implemented in software, hardware, or any combination of software and hardware.

Offline fcap rule accessor 510 receives a request for an offline frequency cap rule or a rule determined by content exchange 120 based on performance data of one or more content delivery campaigns. The request indicates a campaign and, optionally, a publisher and/or a bidder. The request may separately indicate request targets, which include (a) user targets (e.g., geography, demographic information, employment information, work history, and/or academic history of the relevant user) and/or (b) content targets (e.g., a category of the relevant webpage). If content exchange 120 manages content delivery campaigns of different charge types (e.g., CPM, CPC, and CPA), then offline fcap rule accessor 510 determines a charge type of the content delivery campaign indicated/identified in the request. Based on the charge type, offline fcap rule accessor 510 selects the appropriate node in decision tree 520.

For example, if the charge type is CPM (or charge per impression), then offline fcap rule accessor 510 selects a frequency cap rule (if one exists) from interval rule store 440, a frequency cap rule (if one exists) from publisher rule store 446, and a frequency cap rule (if one exists) from bidder rule store 448. Therefore, offline fcap rule accessor 510 may consider up to three different offline frequency cap rules.

Similarly, if the charge type is CPC (or charge per click), then offline fcap rule accessor 510 selects a frequency cap rule (if one exists) from daily rule store 442, a frequency cap rule (if one exists) from publisher rule store 446, and a frequency cap rule (if one exists) from bidder rule store 448. Again, offline fcap rule accessor 510 may consider up to three different offline frequency cap rules.

Similarly, if the charge type is CPA (or charge per action/conversion), then offline fcap rule accessor 510 selects a frequency cap rule (if one exists) from lifetime rule store 444, a frequency cap rule (if one exists) from publisher rule store 446, and a frequency cap rule (if one exists) from bidder rule store 448. Again, offline fcap rule accessor 510 may consider up to three different offline frequency cap rules.

The foregoing examples indicate that charge type dictates which rule stores will be used. However, in another example, all (or at least a different set of) rule stores may be used to retrieve multiple frequency cap rules. For example, daily rule store 442 might not be limited to CPC campaigns. Instead, fcap rule accessor 510 may (additionally or alternatively) select a frequency cap rule from daily rule store 442 for a cpm campaign. As another example, lifetime rule store 444 might not be limited to CPA campaigns. Instead, fcap rule accessor 510 may (additionally or alternatively) select a frequency cap rule from lifetime rule store 444 for a CPC campaign. In fact, fcap rule accessor 510 may access all rule stores for any campaign type.

If offline fcap rule accessor 510 considers multiple offline frequency cap rules, then accessor 510 will select the minimal or most restrictive frequency cap rule. For example, if an interval frequency cap rule is 1 per 30 minutes, a publisher frequency cap rule is 1 per 2 days, and a bidder frequency cap rule is 1 per 3 days, then offline fcap rule accessor 510 will select and return the bidder frequency cap rule.

### Example Process Flow

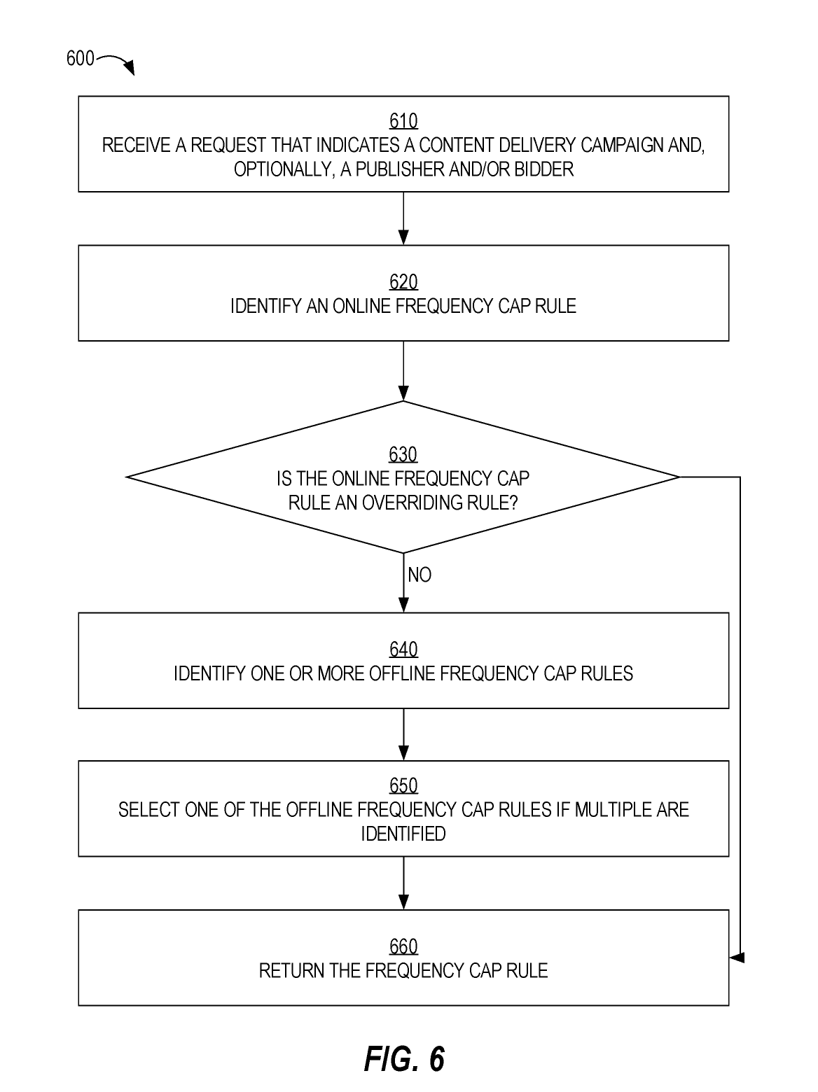

FIG. 6 is a flow diagram that depicts a process 600 for identifying one or more frequency cap rules in response to a request for a frequency cap rule, in an embodiment. The request may originate from an element in content exchange 120, such as content request processor 210. Process 600 may be performed by fcap rule processor 310.

At block 610, a request is received that indicates a content delivery campaign and, optionally, a publisher and/or a bidder. An index matching component (outside of fcap component 220 but part of content exchange 210) may extract all qualified content delivery campaigns. Thus, at the beginning of process 600, multiple content delivery campaigns may be known to be applicable to the current content request from a publisher.

At block 620, one or more “online” (or content provider-specified) frequency cap rules are identified, such as from online fcap rule database 320.

At block 630, it is determined whether any of the online frequency cap rules (identified in block 620) is an overriding (or strict) frequency rule. If so, then process 600 proceeds to block 660, where that frequency cap rule will be associated with that content delivery campaign and returned in response to the request received in block 610.

At block 640, one or more “offline” frequency cap rules are identified, such as from offline fcap rule database 340 or one or more of rule stores 440-448. Block 640 may involve calling offline fcap rule accessor 510, which responds with the one or more offline frequency cap rules.

At block 650, if multiple offline frequency cap rules are identified, then one of them is selected for returning in block 660. As described previously, the minimal offline frequency cap rule may be selected. Alternatively, each rule store may be associated with a certain weight that may change from time to time. The weight is used to determine an offline frequency cap rule. For example, the rule store associated with the highest weight at the time the request is received may be selected. Alternatively, a weighted average of the multiple offline frequency cap rules may be determined.

Process 600 may be performed multiple times, once for each content delivery campaign that is determined relevant to a current content request from a publisher.

Embodiments described herein have significant advantages over current approaches to implementing frequency cap rules. In some embodiments, the frequency cap rules are not pre-determined, fixed rules through a campaign's lifetime, a publisher's lifetime, or a bidder's lifetime. Instead, frequency cap rules are flexible and are performance-aware, taking into account both performance of the content delivery campaigns and user experience.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

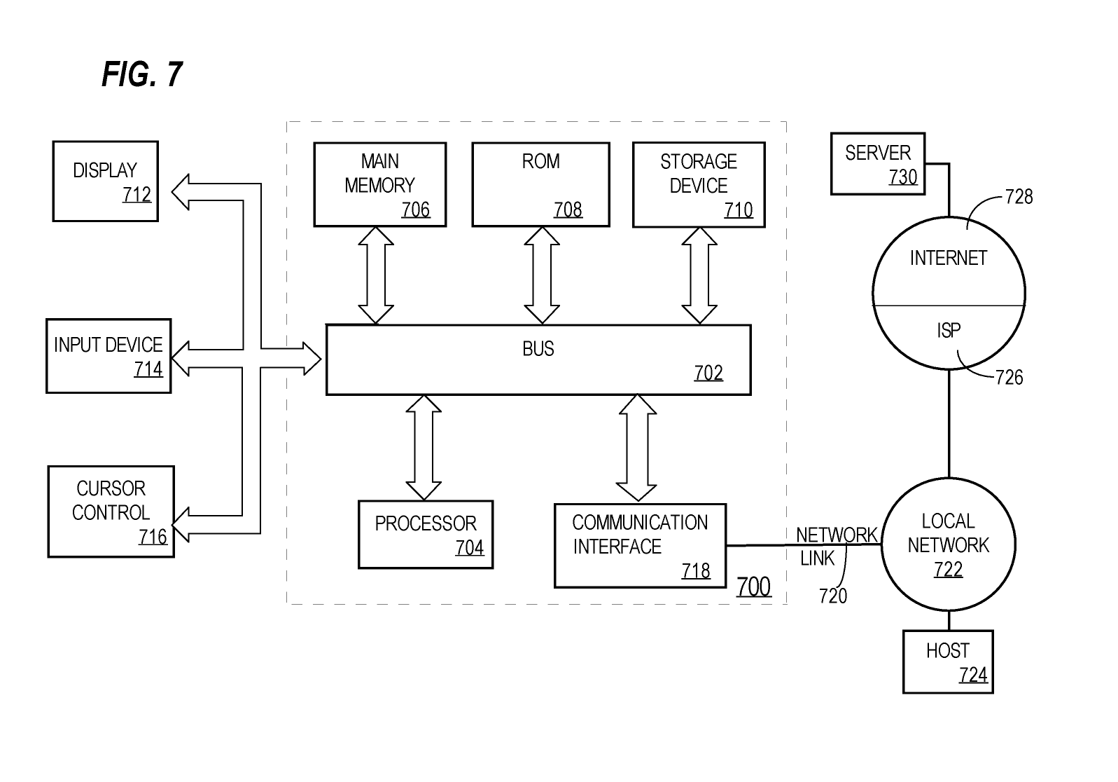

For example, FIG. 7 is a block diagram that illustrates a computer system 700 upon which an embodiment of the invention may be implemented. Computer system 700 includes a bus 702 or other communication mechanism for communicating information, and a hardware processor 704 coupled with bus 702 for processing information. Hardware processor 704 may be, for example, a general purpose microprocessor.

Computer system 700 also includes a main memory 706, such as a random access memory (RAM) or other dynamic storage device, coupled to bus 702 for storing information and instructions to be executed by processor 704. Main memory 706 also may be used for storing temporary variables or other intermediate information during execution of instructions to be executed by processor 704. Such instructions, when stored in non-transitory storage media accessible to processor 704, render computer system 700 into a special-purpose machine that is customized to perform the operations specified in the instructions.

Computer system 700 further includes a read only memory (ROM) 708 or other static storage device coupled to bus 702 for storing static information and instructions for processor 704. A storage device 710, such as a magnetic disk or optical disk, is provided and coupled to bus 702 for storing information and instructions.

Computer system 700 may be coupled via bus 702 to a display 712, such as a cathode ray tube (CRT), for displaying information to a computer user. An input device 714, including alphanumeric and other keys, is coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712. This input device typically has two degrees of freedom in two axes, a first axis (e.g., x) and a second axis (e.g., y), that allows the device to specify positions in a plane.

Computer system 700 may implement the techniques described herein using customized hard-wired logic, one or more ASICs or FPGAs, firmware and/or program logic which in combination with the computer system causes or programs computer system 700 to be a special-purpose machine. According to one embodiment, the techniques herein are performed by computer system 700 in response to processor 704 executing one or more sequences of one or more instructions contained in main memory 706. Such instructions may be read into main memory 706 from another storage medium, such as storage device 710. Execution of the sequences of instructions contained in main memory 706 causes processor 704 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 710. Volatile media includes dynamic memory, such as main memory 706. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 702. Transmission media can also take the form of acoustic or light waves, such as those generated during radio-wave and infra-red data communications.

Various forms of media may be involved in carrying one or more sequences of one or more instructions to processor 704 for execution. For example, the instructions may initially be carried on a magnetic disk or solid state drive of a remote computer. The remote computer can load the instructions into its dynamic memory and send the instructions over a telephone line using a modem. A modem local to computer system 700 can receive the data on the telephone line and use an infra-red transmitter to convert the data to an infra-red signal. An infra-red detector can receive the data carried in the infra-red signal and appropriate circuitry can place the data on bus 702. Bus 702 carries the data to main memory 706, from which processor 704 retrieves and executes the instructions. The instructions received by main memory 706 may optionally be stored on storage device 710 either before or after execution by processor 704.

Computer system 700 also includes a communication interface 718 coupled to bus 702. Communication interface 718 provides a two-way data communication coupling to a network link 720 that is connected to a local network 722. For example, communication interface 718 may be an integrated services digital network (ISDN) card, cable modem, satellite modem, or a modem to provide a data communication connection to a corresponding type of telephone line. As another example, communication interface 718 may be a local area network (LAN) card to provide a data communication connection to a compatible LAN. Wireless links may also be implemented. In any such implementation, communication interface 718 sends and receives electrical, electromagnetic or optical signals that carry digital data streams representing various types of information.

Network link 720 typically provides data communication through one or more networks to other data devices. For example, network link 720 may provide a connection through local network 722 to a host computer 724 or to data equipment operated by an Internet Service Provider (ISP) 726. ISP 726 in turn provides data communication services through the world wide packet data communication network now commonly referred to as the “Internet” 728. Local network 722 and Internet 728 both use electrical, electromagnetic or optical signals that carry digital data streams. The signals through the various networks and the signals on network link 720 and through communication interface 718, which carry the digital data to and from computer system 700, are example forms of transmission media.

Computer system 700 can send messages and receive data, including program code, through the network(s), network link 720 and communication interface 718. In the Internet example, a server 730 might transmit a requested code for an application program through Internet 728, ISP 726, local network 722 and communication interface 718.

The received code may be executed by processor 704 as it is received, and/or stored in storage device 710, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
determining a first frequency cap rule that limits how often one or more content items are to be presented to each user of multiple users over a period of time;
based on the first frequency cap rule, determining whether a first user is to be presented a first content item;
determining a performance of one or more content delivery campaigns that involve delivering content to users;
based on the performance, determining a second frequency cap rule that is different than the first frequency cap rule;
based on the second frequency cap rule, determining whether a second user is to be presented a second content item;
wherein the method is performed by one or more computing devices.

2. The method of claim 1, wherein the second content item is the first content item and is part of the same content delivery campaign.

3. The method of claim 1, wherein the method is performed by a content exchange that determines which content items from different content providers are to be presented to multiple users and that establishes the first frequency cap rule and the second frequency cap rule.

4. The method of claim 3, wherein:
the first content item is from a first content provider;
the second content item is from a second content provider that is different than the first content provider.

5. The method of claim 1, further comprising:
prior to determining, based on the first frequency cap rule, whether the first user is to be presented the first content item, receiving, from a content provider, by a content exchange, the first frequency cap rule;
wherein determining the second frequency cap rule comprises determining, by the content exchange, the second frequency cap rule.

6. The method of claim 1, further comprising:
collecting data about a plurality of user interactions with content items, wherein each user interaction in the plurality of user interactions indicates two or more of: a type of user interaction of a user, a particular content delivery campaign, one or more characteristics of the user that was targeted by the particular content delivery campaign, a display context in which a content item of the particular content delivery campaign was displayed to the user, a type of platform of a computing device employed by the user, a publisher, or a bidder;
wherein determining the performance comprises determining the performance based on at least a subset of the plurality of user interactions.

7. The method of claim 6, further comprising:
using at least a portion of the data to train a statistical model;
wherein determining the second frequency cap rule comprises using the statistical model to determine the second frequency cap rule by inputting, into the statistical model, one or more characteristics of a content delivery campaign to which the second content item belongs, wherein the statistical model outputs, based on the one or more characteristics of the content delivery campaign, the second frequency cap rule or a frequency cap rule that is similar to the second frequency cap rule.

8. The method of claim 6, further comprising:
using at least a portion of the data to train a statistical model;
wherein determining the second frequency cap rule comprises using the statistical model to determine the second frequency cap rule by inputting, into the statistical model, one or more characteristics of the second user, wherein the statistical model outputs, based on the one or more characteristics of the second user, the second frequency cap rule or a frequency cap rule that is similar to the second frequency cap rule.

9. The method of claim 1, further comprising:
receiving, from a content provider, by a content exchange, a goal from among a plurality of possible goals;
wherein the content exchange determines the first frequency cap rule based on the goal.

10. The method of claim 9, wherein the plurality of possible goals include two or more of audience reach, click through rate, or conversion.

11. A method comprising:
receiving a request for one or more frequency cap rules;
in response to receiving the request, identifying a plurality of frequency cap rules;
wherein the plurality of frequency cap rules includes a first frequency cap rule that limits how often one or more content items are to be presented to users over a period of time;
wherein the plurality of frequency cap rules includes a second frequency cap rule that is different than the first frequency cap rule and that limits how often the one or more content items are to be presented to users over the period of time;
determining which of the plurality of frequency cap rules to provide in response to receiving the request;
wherein the method is performed by one or more computing devices.

12. The method of claim 11, wherein determining which of the plurality of frequency cap rules to provide comprises determining which of the plurality of frequency cap rules most limits presentation of the one or more content items.

13. The method of claim 11, further comprising:
storing two or more of:
a first set of interval frequency cap rules, each of which can be used for a content delivery campaign that is charged per impression;
a second set of daily count frequency cap rules, each of which can be used for a content delivery campaign that is charged per click or per impression;
a third set of lifetime frequency cap rules, each of which can be used for a content delivery campaign that is charged per action or conversion or per click;
wherein the request includes data that indicates a particular content delivery campaign;
using the data to select a frequency cap rule from among the first set or the second set.

14. The method of claim 11, further comprising:
storing a first set of interval frequency cap rules, each of which can be applied to delivered impressions, clicks, or conversion and used for content delivery campaigns that are associated with one or more of a plurality of charge types;
storing a second set of daily count frequency cap rules, each of which can be applied to delivered impressions, clicks, or conversions and used for content delivery campaigns that are associated with one or more of the plurality of charge types;
storing a third set of frequency cap rules, each of which can be applied to delivered impressions, clicks, or conversions and used for content delivery campaigns that are associated with one or more of the plurality of charge types;
wherein the plurality of charge types include two or more of a cost per impression, a cost per click, or a cost per conversion or action.
wherein the request includes data that indicates a particular content delivery campaign;
using the data to select a frequency cap rule from among the first set, the second set, or the third set.

15. The method of claim 11, further comprising:
storing a first set of frequency cap rules, each of which is associated with a different content delivery campaign or content provider;
storing a second set of frequency cap rules, each of which is associated with a different publisher;
wherein identifying the plurality of frequency cap rules comprises identifying the first frequency cap rule from the first set of frequency cap rules, wherein the first frequency cap rule is the only frequency cap rule in the plurality of frequency cap rules that is from the first set of frequency cap rules;
wherein identifying the plurality of frequency cap rules comprises identifying the second frequency cap rule from the second set of frequency cap rules, wherein the second frequency cap rule is the only frequency cap rule in the plurality of frequency cap rules that is from the second set of frequency cap rules.

16. The method of claim 11, further comprising:
storing a first set of frequency cap rules, each of which is associated with a different content delivery campaign or content provider;
storing a second set of frequency cap rules, each of which is associated with a different bidder;
wherein identifying the plurality of frequency cap rules comprises identifying the first frequency cap rule from the first set of frequency cap rules, wherein the first frequency cap rule is the only frequency cap rule in the plurality of frequency cap rules that is from the first set of frequency cap rules;
wherein identifying the plurality of frequency cap rules comprises identifying the second frequency cap rule from the second set of frequency cap rules, wherein the second frequency cap rule is the only frequency cap rule in the plurality of frequency cap rules that is from the second set of frequency cap rules.

17. A system comprising:
one or more processors;
one or more storage media storing instructions which, when executed by the one or more processors, cause:
determining a first frequency cap rule that limits how often one or more content items are to be presented to each user of multiple users over a period of time;
based on the first frequency cap rule, determining whether a first user is to be presented a first content item;
determining a performance of one or more content delivery campaigns that involve delivering content to users;
based on the performance, determining a second frequency cap rule that is different than the first frequency cap rule;
based on the second frequency cap rule, determining whether a second user is to be presented a second content item.

18. The system of claim 17, wherein the second content item is the first content item and is part of the same content delivery campaign.

19. The system of claim 17, wherein the steps are performed by a content exchange that determines which content items from different content providers are to be presented to multiple users and that establishes the first frequency cap rule and the second frequency cap rule.

20. The system of claim 19, wherein:
the first content item is from a first content provider;
the second content item is from a second content provider that is different than the first content provider.
